(19) United States
(12) Patent Application Publication
(10) Pub. No.: US 2014/0134576 A1
(43) Pub. Date: May 15, 2014

(54) PERSONALIZED LANGUAGE LEARNING USING LANGUAGE AND LEARNER MODELS

(71) Applicant: MICROSOFT CORPORATION, Redmond, WA (US)

(72) Inventors: Darren Keith Edge, Beijing (CN); Matthew Robert Scott, Beijing (CN); James Landay, Seattle, WA (US)

(73) Assignee: Microsoft Corporation, Redmond, WA (US)

(21) Appl. No.: 13/673,759

(22) Filed: Nov. 9, 2012

(51) Int. Cl. G09B 19/06

(52) U.S. Cl. CPC G09B 19/06
USPC 434/157

(57) ABSTRACT

A two-model personalized language learning system and method that facilitates the learning of a new language (or a language not native to the learner) in a customizable way that is deeply personalized to the learner. Embodiments of the system and method define a learner model including personalized information about the learner and define a language model that describes language information specific to the language. A combination of the learner model and the language model are used to help the learner learn the language. Specifically, the learner and language models are used to create content for flashcards that are displayed to the learner. Responses from the learner are used to update both the learner and language models. Embodiments of the system and method also allow the learner to play skill-based games that teach and reinforce a particular language skill that the learner desires to master.

### BACKGROUND

Many current language learning existing technologies (such as textbooks, podcasts, audio lessons, and desktop software) are impersonal to a learner. In particular, these existing technologies often provide general subject matter instead of providing content that is customized and of personal interest to the learner. Moreover, many of these existing technologies do not allow the learner to proceed at the learner's pace.

Many language learning technologies work across many different languages. There are generally two kinds of language learning technologies. One type is characterized as a language-learning desktop software that includes material directed to a curriculum that someone has decided is suited for a general learner of a certain language. This approach necessitates expensive professional crafting of fixed-progression curricula.

This approach, however, does not support any deviation from the fixed path that has been set. This includes deviation in terms of content and speed of progression through the learning material. For some learners, this approach does not cover the parts of the language that the learner needs, and there is no way to deviate from the fixed path or to personalize the learning.

Another approach is a curriculum-based flash card approach. This approach focuses mainly on vocabulary learning rather than the details of language-specific grammar. The advantage is that this approach works for virtually any language, since every language has vocabulary. The problem with this approach is that it encourages learners to become overly focused on the vocabulary without understanding how words in the language fit together. In addition, the repetitive nature of this approach can lead to the learner becoming quite bored.

Moreover, with both approaches the amount of material given to the learner to learn can become overwhelming. And if the learner is away from the system for a several days, catching up and remembering what was previously learned can become difficult. Neither approach tells the learner which words would be efficient to learn next in order to maximize the value of time spent learning.

These existing technologies often are also specific to a particular device, such as a desktop PC or a mobile phone. This means that these technologies can only support learning in a limited range of contexts (such as when the learner has 30 minutes of free time in a quiet place). Some community-oriented solutions combine coursework, flashcards, and access to native speakers, but do not support deep language and learner modeling.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the two-model personalized language learning system and method facilitate the learning of a new language (or a language not native to the learner) in a way that is deeply personalized to the learner. Support for such learning accounts for several different aspects of the language-learner relationship. Specifically, embodiments of the system and method take into account the learner's knowledge, skills, memory, and interests, the timings and contexts of the learner's learning interactions across a range of devices and applications, and the learner's relationships within larger language learning communities.

Embodiments of the system and method use a combination of a learner model and a language model to help the learner learn the language. Personalized information from the learner model is used to predict when the learner is ready for something new, and the language information from the language model is used to suggest an advantageous and efficient order for the learner to learner. No matter how much time the learner has to practice the language being learned, embodiments of the system and method can fill that time with the experiences the learner needs to keep progressing efficiently.

The learner model is a model of the learner's memory and helps embodiments of the system and method to be adaptive to the learner's needs. More specifically, the learner model describes, for a particular learner, a history of the learner's interactions with the particular language, the learner's current context and state of knowledge and skills, and projections of how these will change over time according to predicted rates of language introduction, reinforcement, and forgetting.

The language model provides a dictionary that shows the learner how the language is used in real-world situations. In particular, the language model describes, for a particular language, language information such as word translations, pronunciations, parts of speech, definitions, frequencies, collocations, usage examples, and usage tags.

Both the learner model and the language model are used to create flashcards that displays flashcard cues to the learner. The learner then responds to the cue. Content of the next flashcard is based on the learner's response. Moreover, the learner model and language model are updated with each response from the learner.

The flashcards also includes badges that may be acquired by the learner. A badge is an indicator of the degree of success the learner has in mastering a particular language skill. The learner may select what type of badges to include on each flashcard. Moreover, each flashcard includes a link to skill-based games and challenges that test the learner's current language skills and help the learner acquire desired badges. The flashcards and games give the learner tools that she needs to learn the language and shows the learner how words work together in order to give the learner a more rounded view of the language.

The skill-based games repeatedly expose the learner to how the words in the language work together. This is performed in a fully dynamic and interactive way with the learner. The skill-based games are driven both by the natural learning order of learning a language based on how words work together and also the learner own desires and interests in particular kinds of words. This provides the learner both with something that the learner wants to learn and the learner needs.

The content of the flashcards and the skill-based games is based on the language model and the learner model. For example, the learner's preferences and retention of skills obtained from the learner model as well as information about what language skill can be learned next from the language model can be taken into account when determining content to display to the learner.

Embodiments of the system and method provide learners with a customizable curriculum of learning the language. For example, some learners desire to use flashcards exclusively, other learners enjoy playing games to learn the language, and still other learners will enjoy some mix of both flashcards ad games. No matter what the learner's personal preference embodiments of the system and method can accommodate the learner and help the learner learn the language in an efficient manner.

It should be noted that alternative embodiments are possible, and steps and elements discussed herein may be changed, added, or eliminated, depending on the particular embodiment. These alternative embodiments include alternative steps and alternative elements that may be used, and structural changes that may be made, without departing from the scope of the invention.

### DRAWINGS DESCRIPTION

Referring now to the drawings in which like reference numbers represent corresponding parts throughout:

FIG. 1 is a block diagram illustrating a general overview of embodiments of the two-model personalized language learning system and method implemented in a computing environment.

FIG. 2 illustrates a simplified example of a general-purpose computer system on which various embodiments and elements of the two-model personalized language learning system and method, as described herein and shown in FIGS. 1 and 3-5, may be implemented.

FIG. 3 is a flow diagram illustrating the general operation of embodiments of the two-model personalized language learning system and method shown in FIG. 1.

FIG. 4 is a flow diagram illustrating the operational details of embodiments of the two-model personalized language learning system and method shown in FIGS. 1 and 3.

FIG. 5 is a block diagram illustrating an exemplary implementation of operational details of embodiments of the two-model personalized language learning system and method shown in FIGS. 1, 3, and 4.

### DETAILED DESCRIPTION

In the following description of embodiments of a two-model personalized language learning system and method reference is made to the accompanying drawings, which form a part thereof, and in which is shown by way of illustration a specific example whereby embodiments of the two-model personalized language learning system and method may be practiced. It is to be understood that other embodiments may be utilized and structural changes may be made without departing from the scope of the claimed subject matter.

### I. System Overview

Embodiments of the two-model personalized language learning system and method allow a learner to learn a language in a way that is deeply personalized for the learner. Embodiments of the system and method take in to account many aspects of the language-learner relationship. Some of these aspects include the learner's knowledge, skills, memory, and interests, the timings and contexts of their learning interactions across a range of devices and applications, and their relationships within larger language learning communities.

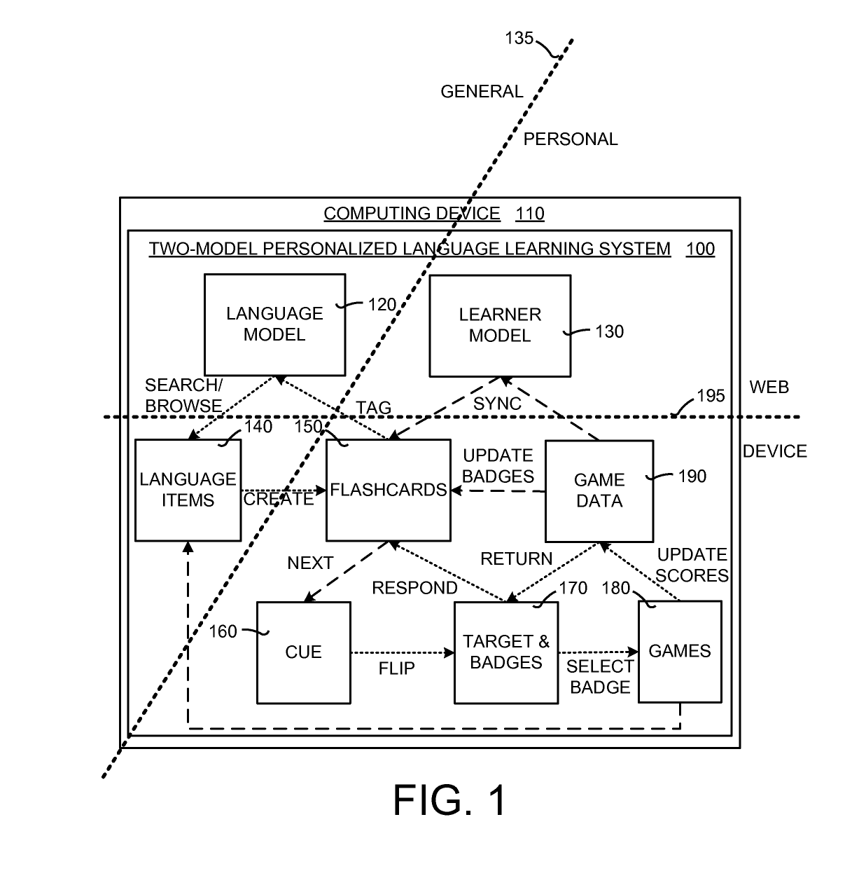

FIG. 1 is a block diagram illustrating a general overview of embodiments of the two-model personalized language learning system 100 and method implemented in a computing environment. In particular, embodiments of the two-model personalized language learning system 100 and method are shown implemented on a computing device 110. The computing device 110 may be virtually any device that includes a processor, such as a desktop computer, notebook computer, and embedded devices such as a mobile phone.

Referring to FIG. 1, embodiments of the system 100 and method include a language model 120 and a learner model 130. The language model 120 describes, for a particular language, language information such as word translations, pronunciations, parts of speech, definitions, frequencies, collocations, usage examples, and usage tags. The learner model 130 describes, for a particular learner, a history of the learner's interactions with the particular language, the learner's current context and state of knowledge and skills, and projections of how these will change over time according to predicted rates of language introduction, reinforcement, and forgetting.

In some embodiments the language model 120 and learner model 130 are stored as web-based services for cross-application, cross-device access, with local caching and state synchronization by applications to accommodate losses in internet connectivity. Different applications rely on different subsets of the language model 120 and learner model 130. However, each necessitate input from both in order to deliver the kind of personalized language learning experiences characterized by embodiments of the system 100 and method.

The first dotted line 135 shown in FIG. 1 indicates division of the environment indicating that items on the one side of the first dotted line 135 are items that are general in nature and are applied to everyone learning the language (such as the language model 120). On the other side of the first dotted line 135 are items that are personalized to a particular learner (such as the learner model 130). Both the language model 120 and the learner model 130 are stored in a cloud or on the Web. This makes them accessible to embedded or mobile devices and across multiple devices. This provides a seamless learning experience no matter the location of the learner or which device the learner is using.

It should be noted that the dotted arrows in FIG. 1 indicate an operation that the learner (not shown) performs. The dashed arrows indicate an operation that the system 100 performs. Embodiments of the system 100 and method include language items 140 that are obtained from the language model 120. The learner can elect to learn (such as how to pronounce a word) and these become flash cards and incorporated into the vocabulary that the learner is trying to master. Using the language items 140, embodiments of the system 100 create flashcards 150. The flashcards 150 help the learner to search and browse the language. The learner can look things up in a variety of ways, view suggestions, and see results.

The flashcards 150 include a cue 160 that is displayed to the learner. This cue may be, for example, a question about the meaning of a vocabulary word. The learner then responds to the cue 160 and flips the flashcard electronically to reveal to the learner a target and badges 170. In some embodiments the target is the correct response that the system 100 is looking for based on the cue 160 displayed. The badges are indicators of the degree of success the learner has in mastering a particular language skill. Based on the response to the cue 160 the content of the next flashcard displayed is updated. In other words, based on how well the learner answers a question determine the content of the next flashcard that is displayed to the learner.

The badges are also entry points into the skill-based games 180. These games 180 teach the particular language skill that the learner is seeking to master. As explained in detail below, embodiments of the system 100 and method include a plurality of different games. Depending on the learner's preferences and learning style, the learner can respond to the flashcards without entering into the games 180 or whenever the learner chooses he can enter into the game environment and play one or more of the games 180. The learner can enter into the games 180 by selecting a badge representing a particular language skill hat the learner would like to acquire. A game then is selected that teaches the learner that particular language skill.

The learner then plays the game and when the game finishes the learner can have the scores saved and updated in the form of game data 190. Moreover, this will also return and update the badges accordingly. For example, if the learner is trying to learn the names of each of the animals, when he enters into a tone game to learn how to pronounce the names of certain animals (such as “cat”), then it is conceivable that the learner will be tested on other things the learner may be using, such as “dog”, “mouse”, and so forth. Depending on whether the learner got them right or wrong, embodiments of the system would take away or add badges.

The game data 190 is used to update the learner model 130 and the learner model 130 in turn is used to suggest and create content for new flashcards 150. The flashcards 150 in turn are used to update the language model 120. New language items then can be used to create new flashcards based on the learner continually learning new material.

Embodiments of the system 100 and method also use the games 180 to suggest new language items. Embodiments of the system 100 and method seek to order the words in the language in an efficient manner so as to maximize the learning experience for the learner. This implies that there is an efficient order and an efficient manner for the particular learner to learn the language. In some embodiments the words that the learner learns next are the words that maximize the value of the words the learner already knows. This value is maximized by certain words being able to be used together. For example, if the learner knows how to say “I” then what should be next? Learning how to say “I have”, or “I want” and so forth can be quite useful.

Embodiments of the system 100 and method work out the ways in which sequences of words in one language map onto sequences of words in another language. Whenever the learner starts learning words, embodiments of the system 100 and method can look in the language model 120 and ask what are the words, phrases, or language chunks that the words occurs in. If embodiments of the system 100 and method throw the words that the learner knows into a bucket and throws the words associated with those words into another bucket, and then determines which words that occurs with high regularity in these phrases or language chunks that a person does not yet know. These are the words most likely to be displayed next to the learner. This maximizes the interconnection between the words that the user already knows.

A second dotted line 195 is used to delineate the separation between items that reside on the Web or in a cloud and those that reside on the computing device 110. As noted above, the language model 120 and the learner model 130 can reside on a cloud or on the Web. This makes them accessible to embedded or mobile devices and across multiple devices.

### II. Exemplary Operating Environment

Before proceeding further with the operational overview and details of embodiments of the two-model personalized language learning system 100 and method, a discussion will now be presented of an exemplary operating environment in which embodiments of the two-model personalized language learning system 100 and method may operate. Embodiments of the two-model personalized language learning system 100 and method described herein are operational within numerous types of general purpose or special purpose computing system environments or configurations.

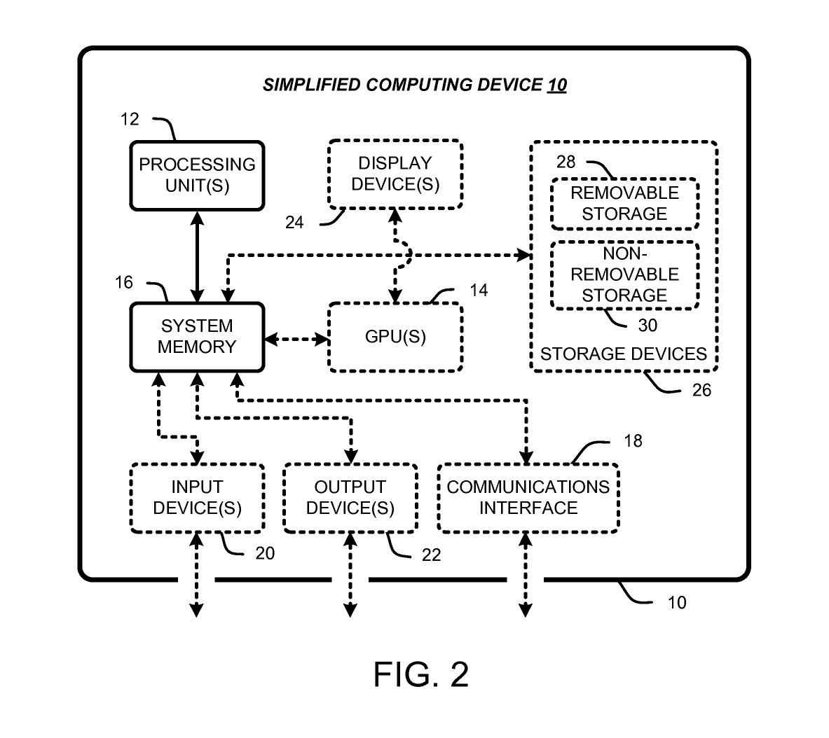

FIG. 2 illustrates a simplified example of a general-purpose computer system on which various embodiments and elements of the two-model personalized language learning system 100 and method, as described herein and shown in FIGS. 1 and 3-5, may be implemented. It should be noted that any boxes that are represented by broken or dashed lines in FIG. 2 represent alternate embodiments of the simplified computing device, and that any or all of these alternate embodiments, as described below, may be used in combination with other alternate embodiments that are described throughout this document.

For example, FIG. 2 shows a general system diagram showing a simplified computing device 10. The simplified computing device 10 may be a simplified version of the computing device 110 shown in FIG. 1. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, and so forth.

To allow a device to implement embodiments of the two-model personalized language learning system 100 and method described herein, the device should have a sufficient computational capability and system memory to enable basic computational operations. In particular, as illustrated by FIG. 2, the computational capability is generally illustrated by one or more processing unit(s) 12, and may also include one or more GPUs 14, either or both in communication with system memory 16. Note that that the processing unit(s) 12 of the general computing device of may be specialized microprocessors, such as a DSP, a VLIW, or other micro-controller, or can be conventional CPUs having one or more processing cores, including specialized GPU-based cores in a multi-core CPU.

In addition, the simplified computing device 10 of FIG. 2 may also include other components, such as, for example, a communications interface 18. The simplified computing device 10 of FIG. 2 may also include one or more conventional computer input devices 20 (e.g., styli (such as the stylus 130 shown in FIG. 1), pointing devices, keyboards, audio input devices, video input devices, haptic input devices, devices for receiving wired or wireless data transmissions, and so forth). The simplified computing device 10 of FIG. 2 may also include other optional components, such as, for example, one or more conventional computer output devices 22 (e.g., display device(s) 24, audio output devices, video output devices, devices for transmitting wired or wireless data transmissions, and so forth). Note that typical communications interfaces 18, input devices 20, output devices 22, and storage devices 26 for general-purpose computers are well known to those skilled in the art, and will not be described in detail herein.

The simplified computing device 10 of FIG. 2 may also include a variety of computer readable media. Computer readable media can be any available media that can be accessed by the simplified computing device 10 via storage devices 26 and includes both volatile and nonvolatile media that is either removable 28 and/or non-removable 30, for storage of information such as computer-readable or computer-executable instructions, data structures, program modules, or other data. By way of example, and not limitation, computer readable media may comprise computer storage media and communication media. Computer storage media includes, but is not limited to, computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices.

Retention of information such as computer-readable or computer-executable instructions, data structures, program modules, and so forth, can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer to a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media.

Further, software, programs, and/or computer program products embodying the some or all of the various embodiments of the two-model personalized language learning system 100 and method described herein, or portions thereof, may be stored, received, transmitted, or read from any desired combination of computer or machine readable media or storage devices and communication media in the form of computer executable instructions or other data structures.

Finally, embodiments of the two-model personalized language learning system 100 and method described herein may be further described in the general context of computer-executable instructions, such as program modules, being executed by a computing device. Generally, program modules include routines, programs, objects, components, data structures, and so forth, which perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

### III. Operational Overview

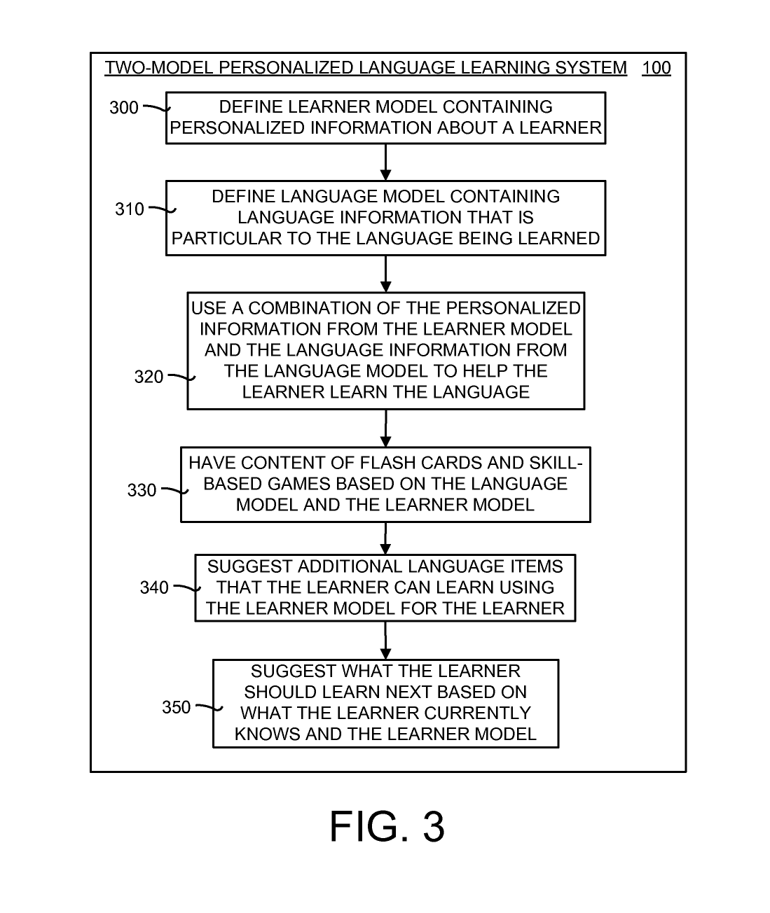

FIG. 3 is a flow diagram illustrating the general operation of embodiments of the two-model personalized language learning system 100 and method shown in FIG. 1. As shown in FIG. 3, the operation of embodiments of the two-model personalized language learning system method begins by defining a learner model that includes personalized information about a particular learner (box 300).

The learner model describes for each learner her history of interactions with the language being learned. Moreover, the learner model includes the learner's current context and state of knowledge and skills, and projections of how these will change over time. These changes are computed according to predicted rates of language introduction, reinforcement, and forgetting. These may be stored and accessed as web-based services by individual learning applications.

Next, embodiments of the system 100 define a language model that includes language information that is particular to the language being learned (box 310). More specifically, the language model describes for each language specific language information such as word translations, pronunciations, parts of speech, definitions, frequencies, and collocations. The language model also includes usage examples, such as in text, audio, or video, and usage tags, such as in speech acts, situations, and locations. This language information may be obtained or mined from corporate or other data sources, professionally curated, crowdsourced on demand, or community generated.

Embodiments of the system 100 use a combination of the personalized information from the learner model and the language information from the language model to help the learner learn the language (box 320). This combination may include any amount of personalized information needed from the learner model combined with any amount of language information needed from the language model to maximize the learner's understanding and retention of the language. This helps embodiments of the system 100 and method to understand how the learner learns and display the material to the learner in an effective and efficient manner. Embodiments of the system 100 and method can be in the form of an application running on a variety of computing devices including mobiles, slates, laptops, desktops, games consoles, and large interactive surfaces. These devices can mediate between the language and learner models to facilitate meaningful learner interactions with the language that update both models accordingly.

Embodiments of the system 100 and method use a combination of flashcards and skill-based games to help the learner to master language skills needed to learn the language. The flashcards are used to test a learner's recall of the displayed language item (such as a character, word, or phrase). Moreover, the flashcard links to an extensible collection of games and challenges that test the learner's current language skills with that language item. As explained in detail below, one such game is a grammar game that teaches high value phrases that can be formed from the set of words currently being learned. Moreover, the game suggests new words to learn based on the learner's “completion” of further such phrases.

Some learners will enjoy more flashcards interaction with the language while other learners will like playing games more to learn the language. The content of the flashcards and the skill-based games is based on the language model and the learner model (box 330). For example, the learner's preferences and retention of skills obtained from the learner model as well as information about what language skill should be learned next from the language model can be taken into account when determining content to display to the learner.

The exemplary implementation of a personalized language learning application based on an adaptive spaced repetition technique and flashcards that not only test learner recall of the displayed language item (such as character, word, phrase), but which link to an extensible collection of games and challenges that test the learner's current language skills with that item. In this exemplary implementation, one such game (the “grammar game”) teaches high value phrases that can be formed from the set of words currently being learned, and suggests new words to learn based on their “completion” of further such phrases.

In addition, embodiments of the system 100 and method suggest additional language items that the learner can learn based on personalized information from the learner model (box 340). For example, if the learner is having trouble retaining a certain language skill then the learner model is aware of this and will suggest that the particular language skill be displayed to the learner more often that another learner may need it displayed. Suggestions as to what the learner should learn next can also be taken into account based on what the learner currently knows and the personalized information in the learner model (box 350).

### IV. Operational Details

The operational details of embodiments of the two-model personalized language learning system 100 and method will now be discussed. Embodiments of the system 100 and method are a distinct combination of knowledge-based learning that uses flashcards and skill-based gaming. Different learners are motivated in different ways. Some learners love hammering through flashcards but get nothing out of games, while other learners love playing games that teach them something but find flashcards quite boring. Embodiments of the system 100 and method let learners find their own balance between flashcards and skill-based gaming to learn a language. In this way embodiments of the system 100 and method can be adapted and personalized to every learner.

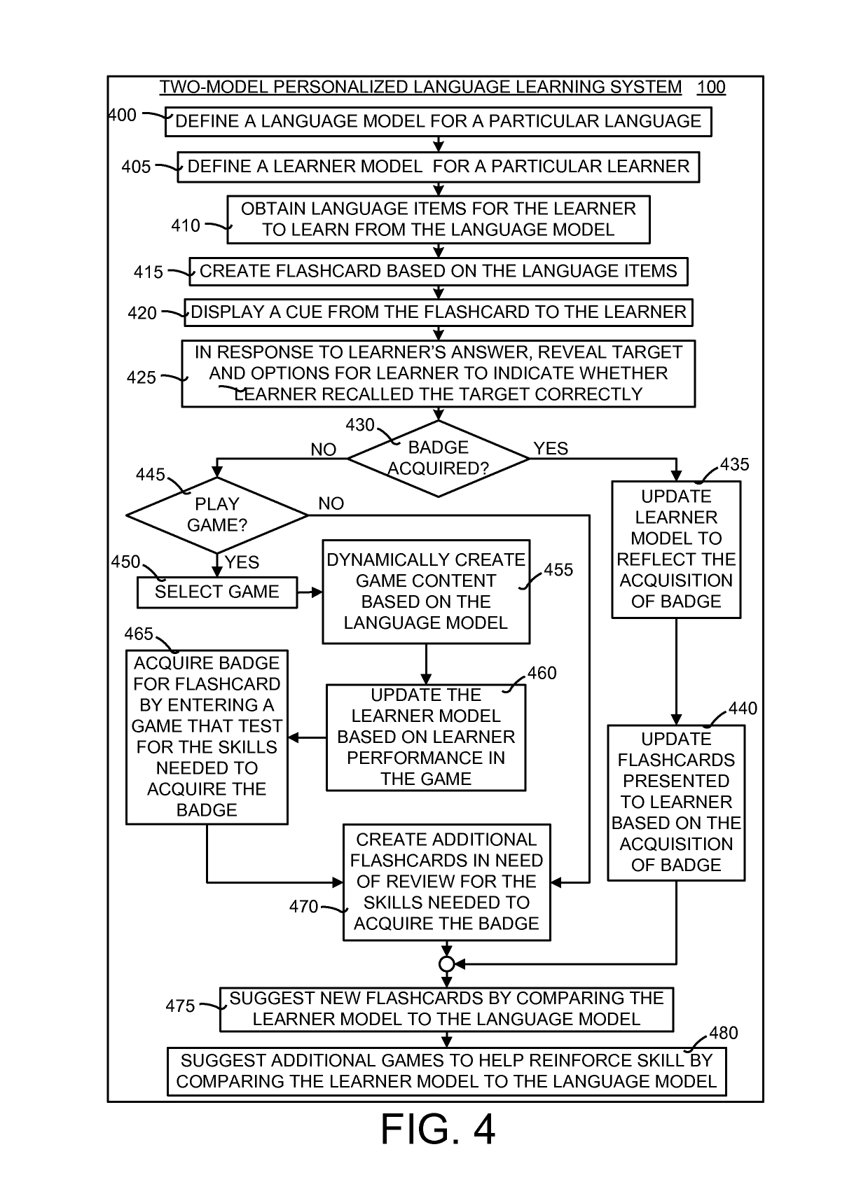

FIG. 4 is a flow diagram illustrating the operational details of embodiments of the two-model personalized language learning system 100 and method shown in FIGS. 1 and 3. As shown in FIG. 4, the operation begins by defining a language model for a particular language (box 400) and defining a learner model for a particular learner (box 405). In other words, the learner model is unique to the particular learner.

Embodiments of the system 100 and method make extensive use of flashcards to display language items to the learner. These language items are language skills that are learned as part of mastering the language. Language items can be things such as vocabulary words, phrases, or verb conjugations. These language items are obtained for the learner to learn from the language model (box 410).

A flashcard is created based on the language items (box 415). Each flashcard first displays a cue to the learner, such a native language word (box 420). At this point the learner attempts to recall the target, which is a second language translation of that native language word. After the learner indicates that he has mentally anticipated a response (or is unable to), then embodiments of the system 100 and method reveal the target and options for the learner to indicate whether they recalled the target correctly (box 425). In alternative embodiments, embodiments of the system 100 and method can use text entry or speech recognition to explicitly evaluate response correctness. Moreover, cues and targets can be displayed through text, audio, or a combination of the two. In addition, text input and speech recognition can also be used to look up language items in either the native or second languages, and flashcards can be create accordingly. In some embodiments the repetition of the flashcards is adaptively spaced according to a model of the learner's memory as well as supporting interaction techniques.

Embodiments of the system 100 and method also include an extensible collection of “badges” associated with each flashcard. These badges are displayed on the reverse side of each flashcard. A badge represents whether the learner has demonstrated the corresponding language skill for that flashcard. In this way a determination is made as to whether a badge has been acquired (box 430). If so, then the learner model is updated to reflect the acquisition of the badge (box 435). In addition, an update occurs of the flashcards that are displayed to the learner based on the acquisition of the badge (box 440).

Otherwise a determination is made as to whether the learner wants to play a game (box 445). If so then a game is selected (box 450). A badge can be earned for a flashcard by selecting the badge on the reverse of the flashcard and entering a short, targeted game that tests the language skill for that flashcard as well as potentially other flashcards in need of review for that skill. Each such game can draw on an aspect of the language model to dynamically create game content based on the language model (box 455). Moreover, the learner model is updated based on the performance of the learner in the game (box 460).

Once the learner has completed the game in a satisfactory manner a badge can be acquired (box 465). Regardless of whether the learner opts to play a game or not, embodiments of the system 100 and method can create for the learner additional flashcards in need of review for the language skills needed to acquire the badge box 470). Additionally, embodiments of the system 100 and method can compare the learner model to the language model to suggest new flashcards that allow the learner to keep progressing in that language skill (box 475). Additionally, embodiments of the system 100 and method can suggest additional games to help reinforce a particular language skill by comparing the learner model to the language model (box 480).

### IV.A. Skill-Based Games

Potential embodiments of skill-based games that may be integrated into flashcard testing will now be discussed. In certain implementations of these games, the learner responds to game screens as quickly and accurately as possible against a countdown timer. Where multiple choices are displayed to the learner, the number and difficulty of the choices can be increased according to the language model as certain criteria are met, such as the total number of correct answers.

Games entered from a particular flashcard typically pay special attention to testing the language skill for that flashcard. However, games can also be played in a free mode where the game uses the learner and language models to test the flashcard content due for review. Games can add and remove badges to any of the flashcards whose content is used in the game using such criteria as “add the badge if the last response was correct” and “remove the badge if the last response was incorrect”. The games also can contribute scores to high score tables as well as global measures of how much or how well that skill has been demonstrated for the language items in the learner model. These can be combined to give the learner a single figure metric of their language knowledge further demonstrated in the skill-based games they care about.

It is possible to reduce the idea of learning the language into a single score or metric that the learner can track. Moreover, the score allows the learner to see and track her progress and improvement over time and to see how much the learner knows at a particular instant in time. Knowledge of a flash card is only one indicator of whether the learner knows the word or the language skill. And just because the learner knows a word does not mean he knows how to use it. The score help quantitatively measure the learner's ability to demonstrate the skill through the games.

In some embodiments the following equation is used,

$$Score = Estimate of flashcards known \times {\prod }_{skill games} Proportion of flashcards with skill game badge$$

to calculate an overall score based on the learner model. In this embodiment the score equals an estimate of how many cards are known times the product of each of the skill games the user is using and the proportion of the flashcards with that badge corresponding to a particular language skill. For example, if the learner knows 100 vocabulary words but only knows the tones for half of the words and only knows the characters for half of the words, then the score is 100×0.5×0.5=25. This is just one embodiment of obtaining a score. Another embodiment could use how many cards the user knows that have each of the badges that the learner desires to acquire. This would produce another score.

### IV.A.1. Grammar Game

Some embodiments of the system 100 and method include a grammar game. In this game, high-quality phrase translations (that is, translations of common word sequences) are used to teach the learner the ways in which the words she is learning can be used together. These may be derived using a variety of sources, such as n-gram data, the phrase table of a statistical machine translation engine, or from learner input with assistance from these other sources.

In one example of such a grammar game, a target second language phrase including the parent flashcard vocabulary item is shown along with multiple possible native language translations, each of which is derived from second language phrases that are similar to the target phrase. Successful answers from the learner explicitly indicate the learner's understanding of the phrase's constituent words and implicitly reinforce correct grammatical relations between words.

Moreover, in this embodiment the grammar game can also suggest new language items to maximize the number of new, high value phrases from the language model that are “completed” by the combination of the new item and items already being learned in the learner model. In alternate embodiments, the grammar game can balance this “connectionist” introduction of phrase completing items with the “frequentist” introduction of frequent items from the language model that are not currently in the learner model.

### IV.A.2. Sentence Game

Some embodiments of the system 100 and method include a sentence game. In this game, high-quality sentence translations are used to teach the learner the ways in which the words she is learning can be used together in a sentence. These may be derived using a variety of sources, such as examples from bilingual dictionaries or they may be mined from parallel texts on the Web.

In some embodiments of the sentence game, a native language sentence is shown whose second language translation includes the parent flashcard vocabulary item. In still other embodiments, each of the words of the second language sentence is displayed in a random arrangement and the learner seeks to place or select them in the correct order to proceed. This game can also suggest new language items to maximize the number of new sentences from the language model that are “completed” by the combination of the new item and items already being learned in the learner model.

### IV.A.3. Sound Game

Some embodiments of the system 100 and method include a sound game. In this game, the learner is taught to differentiate between similar sounding items in the second language (or the language being learned). Similar items can be computed using measures of phonetic similarity. In some embodiments the sound of a native language word is played to the learner. In other embodiments the native language definition of a second language word is shown to the learner. In each of these embodiments the learner selects the corresponding textual representation of the second language word. Embodiments of the sound game can also suggest new language items to increase the degree of phonetic similarity within the learning model, increasing the need for phonetic discrimination acuity.

### IV.A.4. Sight Game

Some embodiments of the system 100 and method include a sight game. Embodiments of this game test the learner's ability to recognize a character in the language being learned. In some embodiments the game teaches the learner to differentiate between similar looking items in the second language orthography. This is especially relevant for East Asian character sets.

In addition, similar items can be computed using measures of visual similarity. In some embodiments of the sight game the native language definition of a second language word is shown to the learner and the learner selects the visual representation of the corresponding second language word. This game can also suggest new language items to increase the degree of visual similarity within the learning model, thereby increasing the need for visual discrimination acuity.

### V. Exemplary Implementation

An exemplary implementation of embodiments of the two-model personalized language learning system 100 and method will now be presented. It should be noted that this example is one of several embodiments that are possible.

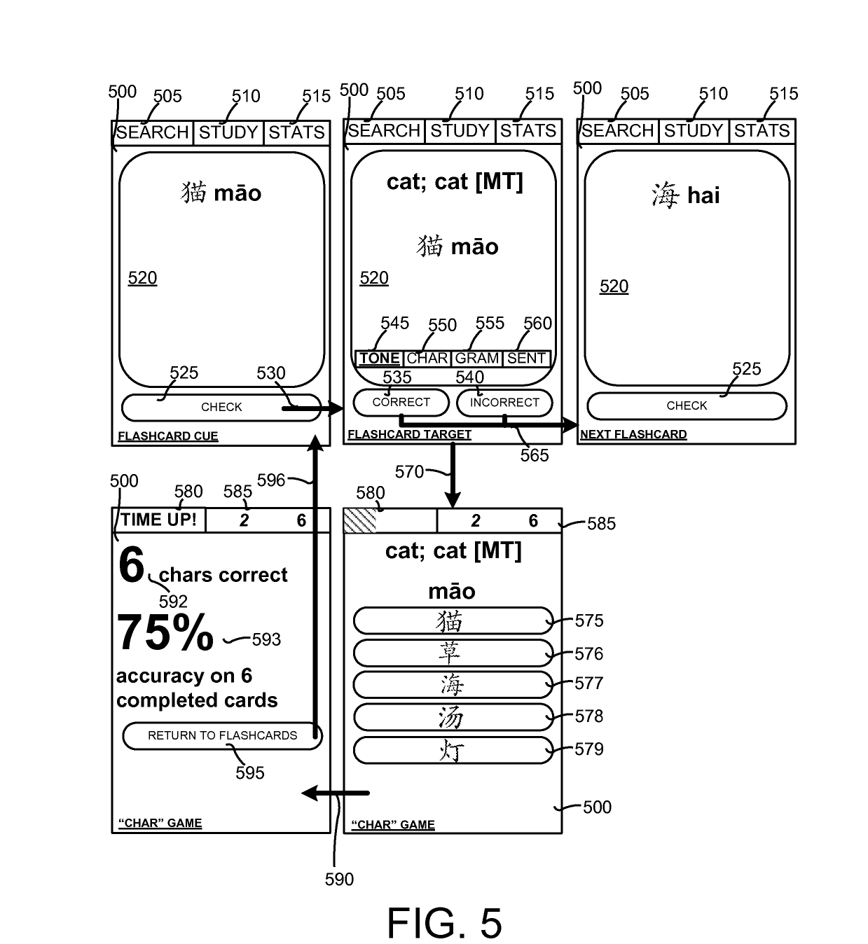

FIG. 5 is a block diagram illustrating an exemplary implementation of operational details of embodiments of the two-model personalized language learning system and method shown in FIGS. 1, 3, and 4. In FIG. 5 the two-model personalized language learning system and method is shown implemented on a mobile device 500. Moreover, FIG. 5 illustrates five different screenshots of this particular embodiment of the system 100 and method.

The first screenshot of this embodiment is shown in FIG. 5 in the top row and the leftmost screenshot. Moreover, it is denoted as the “flashcard cue” in the bottom leftmost corner of the screenshot. This first screenshot shows a search tab 505, a study tab 510, and a stats (or statistics) tab 515. The search tab 505 allows the learner to search for a particular word or phrase. On the “search” page the learner is presented with interface to enable the learner to look up language. In some embodiments the search results can be augmented with suggestions, such as suggesting the next thing that should be learned by the learner. The study tab 510 allows the learner to study the flashcards, and is the flashcards and games interface). The stats tab 515 allows the learner to view statistics about his learning and lets the learner see how he is progressing in learning the language.

In the first screenshot the system 100 and method are in the study mode, which is entered after the learner has depressed the study tab 510. A study area 520 includes a word and a Chinese character, “mao.” This Chinese word and character means something in English. The idea is that the learner responds to the flashcard cue with an answer and then hits the check button 525 to see actual word meaning. The first arrow 530 shows the flow from the first screenshot to a second screenshot after the learner has pushed the check button 525.

The second screenshot is shown in the top row, middle screenshot in FIG. 5. Moreover, it is denoted as the “flashcard target” in the bottom leftmost corner of the screenshot. If the learner correctly responds to the flashcard cue then she can hit a “correct” button 535 to move on to the next flashcard. If the response is incorrect then the learner presses an “incorrect” button 540 and moves on to the next flashcard.

The second screenshot also illustrates some badges near the bottom of the study area 520. The learner has the option to add or remove badges to the flashcard that the learner desires to acquire. For example, assume that the learner cares about getting the tones of the Chinese characters just right. In this case, the learner can have added to the flashcards a tone badge. If the learner does not really care about games, then the learner does not need to invest in this type of capability. But the ability to add this capability later on is available.

The badges shown in FIG. 5 in the second screenshot include a tone badge 545, a char (or character) badge 550, a gram (or grammar) badge 555, and a sent (or sentence) badge 560. Moreover, it can be seen that the tone badge 545 is underlined. This indicates that the learner has acquired the tone badge 545 by demonstrating the tone skill for that particular flash card. The absence of any underlining for the char badge 550, the gram badge 555, and the sent badge 560 indicates that the learner has not demonstrated that language skill for the particular flash card.

The learner can make a choice at this particular time. If the learner wants to go one to the next flashcard she can press the correct button 535 or the incorrect button 540, depending on whether her response to the flashcard cue was correct. The next flashcard is shown in the third screenshot, which is the top row and rightmost screenshot. Moreover, the third screenshot is labeled in the lower leftmost corner as the “next flashcard.” The second arrow 565 shows the flow from the second screenshot to a third screenshot after the learner has pushed the check button 525.

As shown in the third screenshot, the study area includes a word and a Chinese character, “hai.” As with the previous flashcard the learner responds to the flashcard cue with an answer and then hits the check button 525 to see actual word meaning.

If the learner decides that he wants to earn or acquire a particular badge, or badges for other flashcards, then he can click on the desired badge and then enter into a gaming environment. In this gaming environment the learner is working against the clock to get as many correct answers as possible as quickly as possible while maintaining a certain accuracy. Thus, the learner may enter into a game from a flashcard when the learner sees the English definition (such as “cat”). The third arrow 570 shows the flow from the second screenshot to a fourth screenshot after the learner has pushed the char badge 550.

The fourth screenshot illustrates the character game. The fourth screenshot is in the second row and the rightmost screenshot in FIG. 5. Moreover, it is denoted as the “′char′ game” in the bottom leftmost corner of the fourth screenshot. Looking at the fourth screenshot it can be seen that it says “cat” in English and then below it has the Chinese word for cat that is “mao.”

Then are displayed five characters that look similar. In particular, a first button 575 includes a first character, a second button 576 includes a second character, a third button 577 includes a third character, a fourth button 578 includes a fourth character, and a fifth button 579 includes a fifth character. The goal of the learner is to select the correct character for the given word.

The learner may respond correctly or incorrectly. Depending on how well the learner performs in the character game the score either goes up or down. The idea is that if the learner started the game through a particular flashcard, the system 100 and method will give the learner a particular emphasis on that flashcard. For example, within four or five screens the learner can be tested on the character for “cat.” Other words can also be pulled in that the learner would like to acquire a to earn a badge for, that he needs to review, or that may go along with the word “cat.” This gives the learner a breadth of exposure to other words other than the word on the entry flashcard.

The fourth screenshot also includes timer 585 that indicates how much time is remaining in the game. In addition, the fourth screenshot includes a scoreboard 585 that illustrates to the learner how many incorrect responses she has given (the first number) and how many correct responses have been given (the second number).

Once time expires the learner is presented with a score. This gives the user a sense of fun playing a game while learning. A fifth screenshot illustrates the score screen in the character game. The fifth screenshot is in the second row and the leftmost screenshot in FIG. 5. A fourth arrow 590 shows the flow from the fourth screenshot to the fifth screenshot after time has expired in the character game.

The fifth screenshot displays to the learner a number of characters correct 592 and a percent accuracy on the number of completed cards 593. The fifth screenshot also includes a “return to flashcards” button 595. If the learner is finished playing games then she can return to the flashcards. A fifth arrow 596 shows the flow from the fifth screenshot back to the first screenshot (representing the flashcard cue) after time the learner has pressed the “return to flashcards” button 595.

Pressing the sent badge 560 takes the learner to a sentence game that uses high-quality sentence pairs in English and Chinese. Something that is often lacking as a language learner is sentence level material at the learner's level. These embodiments of the system 100 and method present the English sentence and the Chinese words jumbled up. In this sentence game the learner has to organize them into a grammatically correct sentence. This type of hands-on learning is typically absent from the flashcard environment. Just like with the grammar game, the system can suggests words to learn to open up the opportunity for additional sentences. The learner is constantly learning things that he does not know in the context of things that he does know. This is a powerful concept.

In a general learning session the learner could look at four flashcards and then play a several different games, and continue this for each set of flashcards. Different learners will typically like different approaches and a different mix of flashcards and games. These preferences can be adapted to the learner's learning style. This also gives the learner more exposure to the language and makes learning the language more fun since it is adapted to the learner's individual learning style. Moreover, embodiments of the system 100 and method can suggest language items that the learner might like to convert into flash cards and also suggest the next flash card for the learner to learn.

### VI. Alternate Embodiments

Several alternate embodiments of the two-model personalized language learning system 100 and method are possible. The language model and the learner model can also be used to create personalized language learning experiences beyond the flashcard environment and yet still provide feedback into the system 100 through the badge and suggestion mechanisms.

In one embodiment a bilingual desktop or browser environment is created by analyzing displayed text and substituting native language phrases for second language translations from the language model that fully comprise words from the learner model. Optical character recognition can be used in the desktop case, and document object model manipulation can be used in the browser case. In both cases, extra controls can be overlaid or inserted into the underlying text that allows the learner to provide feedback on their understanding of the text. The same mechanism can be used when reading text in the second language. The feedback from these implicit indications of comprehension can dynamically bootstrap the learner model for more advanced learners. Encountering and understanding words in these contexts could feed back onto the flashcards as further badges, while unknown words could be directly added as flashcards to the learner model.

Another embodiments is the integration of flashcard language items and language items appearing in language learning games or other interactive experiences. Flashcard vocabulary can be dynamically incorporated into game content and tasks, and language introduced by the game could be dynamically inserted into the learner's flashcards. For example, a game could be used to help the learner understand the language of space and motion by issuing commands in the second language such as the translation of “step forwards then raise your right hand.”

Game feedback could draw arrows on the live video of the learner, as well as show native translations whenever the learner fails to respond by moving her body correctly. For example, commands such as “put the blue ball in the green box”, where “put” and “in” are spatial words being taught to the learner, and “blue”, “green”, “ball”, and “box” are part of the non-spatial game vocabulary adding to flashcard language items in the learner model. These objects can be displayed around the learner in a virtual world or in an augmented reality video overlay, and can also draw on the learner model for arbitrary nouns with associated visual representations. For example, in the above command, the image of a ball could be moved by the learner into the image of a box but ball and box could equally well be other noun pairs with the appropriate containment relationship in the language model, such as car and garage.

In still another embodiment, the system 100 and method can include capture and feedback on second language conversations. Embodiments of the system 100 and method can give feedback on how the learner's language interaction is with native speakers. And someone who is giving the learner feedback can tap into the language and learner models. This can be used to suggest things for the learner to learn.

An example application could have the learner using his mobile device to capture the audio of an attempted conversation in the second language. This captured audio then is sent to a teacher, online labor market, or language learning community for transcription, translation, correction, and suggestion. Words marked as being appropriately used in conversation could receive badges accordingly (which would link to these uses within the recordings). Moreover, new second language vocabulary in the transcriptions of the other speakers, translations of native language vocabulary used, corrections of the learner, or suggestions of what else might be useful in similar situations, can be converted into flashcards and added to the learner model.

Another embodiments uses the learner model to create a custom speech recognition engine that recognizes sentences using only the learner's vocabulary In one application the learner could read appropriate sentences from the language model and be scored based on the closeness of the text of the recognized speech. As the learner expands her vocabulary this automatically becomes more difficult.

In some embodiments the system 100 and method restrict the language of the speech recognition engine to only the words that the learner knows. The speech recognition engine grows with the learner as the learner expands her language skills. This allows the learner to test her language skills with the computer where the learner says things in a free-form fashion that the computer does not have any knowledge of in advance.

Another embodiment is the use of contextual tags within the language model to suggest contextually relevant language as flashcards. For example, learners could tag flashcards as “relevant now” to associate that language with the learner's current context determined by the time, geographic location (such as from a mobile GPS), place type, learner motion (such as from mobile accelerometer data), and so on. This provides a database of language that the learner may want to use at a particular location.

The learner could also tag the language with “relevant how”, for example with the word “taxi”. Machine learning can be used to infer which “relevant how” categories apply to the context determined by “now” for the learner, identifying salient patterns (such as “taxi” applies to learning in a car as determined by accelerometer data, whereas “home” applies to learning in a particular area (such as determined by GPS). This not only helps the application automatically present language items that are “relevant now”, but draws on the community of learners to suggest related flashcards to learn, such as items also tagged with “taxi” by other learners (using standard criteria for collaborative filtering). The “relevant now” button and “relevant how” fields can be incorporated alongside the badges on each flashcard.

Yet another embodiment is the creation of a social network around flashcard study and use in skill-based games and challenges. This could be a community of people are learning a particular language. This allows the learner to share achievements with people to whom the learner is connected. Moreover, embodiments of the system 100 and method can use the learner model to connect the learner with others that may benefit the learner and vice versa.

In one example, learner models for both the learner's native and second languages are analyzed and the corresponding language models used to suggest language partners for the learner. This can be done in both directions. In other words, embodiments of the system 100 and method can suggest learners at the same level that share a native language and are learning the same second language, and learners at the same level but with native and target languages reversed. In this example, learners could “follow” the actions and achievements of their social network contacts, and receive automatic suggestions, such as for language items known by a majority of learners with similar learner models, but not by the learner.

Moreover, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1-20. (canceled)

21. A method for personalizing learning of a language for a learner executed by a processor of a computing device, comprising:
accessing, utilizing the computing device, a learner model that describes personalized information about the learner who is learning the language;
accessing, utilizing the computing device, a language model that describes language information particular to the language;
creating a flashcard based upon the personalized information from the learner model and the language information from the language model, wherein the flashcard comprises:
a cue for a language item, wherein the language item is one of a character, a word, or a phrase in the language, and wherein the cue is a question about a meaning of the language item;
a target for the language item, wherein the target is a correct response to the cue; and
a badge that links to a skill-based game that tests a language skill pertaining to the language item; and
displaying the flashcard on a display device of the computing device.

22. The method of claim 21, wherein the computing device accesses the learner model and the language model from computer-readable storage of the computing device.

23. The method of claim 21, wherein the computing device accesses the learner model and the language model from computer-readable storage of a disparate computing device.

24. The method of claim 21, wherein the personalized information of the learner model comprises at least one of: (a) a history of the learner's interactions with the language; (b) the learner's current context and state of knowledge and skills of the language; or (c) projections of how the personalized information will change over time according to predicted rates of language introduction, reinforcement, and forgetting.

25. The method of claim 21, wherein the language information of the language model comprises at least one of: (a) word translations; (b) pronunciations; (c) parts of speech; (d) definitions; (e) frequencies; (f) collocations; (g) usage examples; or (h) usage tags.

26. The method of claim 21, wherein displaying the flashcard on the display device of the computing device further comprises:
displaying the cue on the display device of the computing device; and
responsive to receipt of a response, displaying the target and the badge on the display device of the computing device.

27. The method of claim 21, further comprising selecting content for the skill-based game based on the personalized information from the learner model and the language information from the language model.

28. The method of claim 21, further comprising creating a second flashcard based upon the personalized information from the learner model, the language information from the language model, and a response to the flashcard.

29. The method of claim 21, wherein the badge is an indication of a degree of success of learning the language skill associated with the language item.

30. The method of claim 21, further comprising:
responsive to a selection of the badge, presenting the skill-based game on the display device of the computing device; and
producing a score of a performance of the learner in the skill-based game.

31. The method of claim 30, further comprising updating the learner model based upon the score of the performance of the learner in the skill-based game.

32. The method of claim 30, further comprising updating the badge based upon the score of the performance of the learner in the skill-based game.

33. The method of claim 21, wherein the skill-based game is a grammar game, the method further comprising:
responsive to a selection of the badge:
presenting a target phrase in the language on the display device of the computing device, wherein the target phrase comprises the language item; and
presenting possible translations of the target phrase in a native language of the learner on the display device of the computing device, wherein one of the possible translations is a translation of the target phrase in the native language of the learner and a remainder of the possible translations are derived from phrases that are similar to the target phrase in the language; and
receiving a selection of one of the possible translations of the target phrase.

34. The method of claim 33, further comprising selecting new language items to use in the grammar game by finding most frequently used language items from the language model that are not currently in the learner model.

35. A computing device for personalizing learning of a language for a learner, comprising:
a processing unit; and
a memory coupled to the processing unit, the memory storing computer-executable instructions for causing the processing unit to:
access a learner model that describes personalized information about the learner who is learning the language;
access a language model that describes language information particular to the language;
create a first flashcard based upon the personalized information from the learner model and the language information from the language model, wherein the first flashcard comprises:
a cue for a language item, wherein the language item is one of a character, a word, or a phrase in the language, and wherein the cue is a question about a meaning of the language item;
a target for the language item, wherein the target is a correct response to the cue; and
a badge that links to a skill-based game that tests a language skill pertaining to the language item;
display the cue of the first flashcard on a display device of the computing device display;
responsive to receipt of a response, display the target and the badge of the first flashcard on the display device of the computing device; and
create a second flashcard based upon the personalized information from the learner model, the language information from the language model, and the response to the flashcard.

36. The computing device of claim 35, wherein the memory further stores computer-executable instructions for causing the processing unit to:
responsive to a selection of the badge, present the skill-based game on the display device of the computing device;
produce a score of a performance of the learner in the skill-based game;
update the learner model based upon the score of the performance of the learner in the skill-based game; and
update the badge based upon the score of the performance of the learner in the skill-based game.

37. The computing device of claim 35, wherein the memory further stores the learner model and the language model.

38. The computing device of claim 35, wherein the memory further stores computer-executable instructions for causing the processing unit to:
select content for the skill-based game based on the personalized information from the learner model and the language information from the language model.

39. The computing device of claim 35, wherein the skill-based game is a grammar game, and wherein the memory further stores computer-executable instructions for causing the processing unit to:
responsive to a selection of the badge:
present a target phrase in the language on the display device of the computing device, wherein the target phrase comprises the language item; and
present possible translations of the target phrase in a native language of the learner on the display device of the computing device, wherein one of the possible translations is a translation of the target phrase in the native language of the learner and a remainder of the possible translations are derived from phrases that are similar to the target phrase in the language; and
receive a selection of one of the possible translations of the target phrase.

40. A method for personalizing learning of a language for a learner executed by a processor of a computing device, comprising:
accessing, utilizing the computing device, a learner model that describes personalized information about the learner who is learning the language;
accessing, utilizing the computing device, a language model that describes language information particular to the language;
obtaining a language item from the language model, wherein the language item is one of a character, a word, or a phrase in the language;
creating a flashcard based upon the personalized information from the learner model and the language information from the language model, wherein the flashcard comprises:
a cue for the language item, wherein the cue is a question about a meaning of the language item;
a target for the language item, wherein the target is a correct response to the cue; and
a badge that links to a skill-based game that tests a language skill pertaining to the language item;
displaying the cue of the flashcard on a display device of the computing device;
responsive to receipt of a response, displaying the target and the badge of the flashcard on the display device of the computing device;
responsive to selection of the badge, presenting the skill-based game on the display device of the computing device;
creating content for the skill-based game based on the personalized information from the learner model and the language information from the language model;
producing a score of a performance of the learner in the skill-based game; and
updating the learner model based upon the score of the performance of the learner in the skill-based game.
